(19) United States
(12) Patent Application Publication
(10) Pub. No.: US 2026/0200535 A1
(43) Pub. Date: Jul. 16, 2026

(54) UNDERBODY PROTECTION FOR MOTOR VEHICLES, MOTOR VEHICLE HAVING UNDERBODY PROTECTION, AND METHOD FOR PRODUCING UNDERBODY PROTECTION

(71) Applicant: KAUTEX TEXTRON GMBH & CO. KG, Bonn (DE)

(72) Inventor: Daniel HEIDRICH, Rommerskirchen (DE)

(21) Appl. No.: 19/136,748

(22) PCT Filed: Dec. 7, 2023
(86) PCT No.: PCT/EP2023/084778

§ 371 Date: Jun. 6, 2025

(30) Foreign Application Priority Data
Dec. 8, 2022 (DE) 10 2022 132 714.0

(51) Int. Cl. B62D 25/20; B60K 1/04

(52) U.S. Cl. CPC B62D 25/20; B60K 1/04; B60K 2001/0438

(57) ABSTRACT

An underbody protection for a motor vehicle includes at least one first protective element, a support structure with a plurality of ribs and at least one second protective element, whereby the support structure is sandwiched between the first protective element and the second protective element and is connected to each of these, and wherein the ribs extend between the first protective element and the second protective element, so that a plurality of cavities are formed between the first protective element and the second protective element.

The present invention relates to an underbody protection for motor vehicles, in particular for electric motor vehicles. Furthermore, the present invention relates to a motor vehicle, in particular an electric motor vehicle with an underbody protection and a method for producing an underbody protection.

Various types of underbody protection systems are known from the prior art. Mainly heavy steel plates or welded steel assemblies are used as underbody protection to absorb the high intrusion force and impact energy when vehicles dynamically hit obstacles. Such underbody protection systems increase the overall weight of the vehicle. In addition, underbody protection made of steel has an increased risk of corrosion.

The problem underlying the invention is to provide an underbody protection that has high rigidity and energy absorption capacity while being lightweight.

The problem underlying the present invention is solved by an underbody protection according to claim 1. Advantageous embodiments of the underbody protection are described in the claims dependent on claim 1.

More specifically, the problem underlying the present invention is solved by an underbody protection for a motor vehicle comprising at least one first protective element, a support structure having a plurality of ribs and at least one second protective element. The support structure is sandwiched between the first protective element and the second protective element and is connected to each of these, wherein the ribs extend between the first protective element and the second protective element, so that a plurality of cavities are formed between the first protective element and the second protective element.

The underbody protection according to the invention has the advantage that the protective effect of the underbody protection is increased against a mechanical impact, for example by a collision. The second protective element can deform in the cavities of the support structure in the event of a mechanical impact, for example due to an impact caused by the dynamic contact of a motor vehicle with a surface, and convert the energy generated by the impact into mechanical deformation energy. The first protective element is thereby protected from deformation due to the deformation of the second protective element into the cavities of the underbody protection, so that components of the motor vehicle located above the first protective element are effectively protected. As a result, the underbody protection has an increased protective effect against mechanical impact.

The underbody protection is designed for a motor vehicle, in particular for an electrically powered vehicle.

The first protective element and/or the second protective element can also be referred to as the first protective plate and/or the second protective plate.

According to the feature that the support structure is sandwiched between the first protective element and the second protective element, at least parts of the support structure are sandwiched, at least in sections, between the first protective element and the second protective element. For example, the ribs are sandwiched between the first protective element and the second protective element.

The first protective element and/or the second protective element can be designed as a substantially flat component. A substantially flat component within the meaning of the present invention has a first direction of extension, a second direction of extension and a third direction of extension. The third direction of extension is significantly smaller than the first direction of extension and the second direction of extension. The third direction of extension can also be referred to as the thickness extension. The first direction of extension can also be referred to as the longitudinal extension. The second extension direction can also be referred to as the width extension. All three directions of extension are orthogonal to each other.

The first protective element can have a first connecting surface. The first connecting surface can be arranged parallel to the planes spanned by the longitudinal extension and the width extension of the first protective element. In other words, the first connecting surface may be arranged orthogonally to the thickness extension of the first protective element.

The second protective element can have a second connecting surface. The second connecting surface can be arranged parallel to the planes spanned by the longitudinal extension and the width extension of the second protective element. In other words, the second connecting surface can be arranged orthogonally to the thickness extension of the second protective element.

The support structure can have a base plate. The base plate of the support structure can be designed as an essentially flat component.

According to the feature that the support structure has a plurality of ribs, it is meant that the support structure has at least two ribs. A first subset of the ribs can, for example, be aligned parallel to one another, and a second subset of the ribs can be aligned in a crossed manner with respect to the first subset of the ribs.

The support structure can comprise a plastic, in particular a thermoplastic and/or thermosetting plastic.

The support structure can be made of fiber-reinforced plastic, at least in sections. This can improve the bending stiffness of the underbody protection.

The support structure can have long fibers and/or continuous fibers. This can further improve the bending stiffness of the underbody protection.

The fibers of the support structure can be glass fibers and/or carbon fibers and/or aramid fibers.

According to the feature that the support structure is sandwiched between the first protective element and the second protective element and is connected to each of these, it is meant that, starting from the first protective element, the support structure is arranged first and is connected to the first protective element. In particular, the first protective element is connected to the support structure in such a way that the thickness extension of the first protective element runs parallel to the thickness extension of the base plate of the support structure, at least in sections. The second protective element is arranged on the support structure and connected to it in such a way that the thickness extension of the base plate of the support structure and the thickness extension of the second protective element run parallel to each other, at least in sections. In other words, the first protective element and the second protective element are arranged on two opposite sides of the support structure on the support structure and are connected thereto.

The ribs can extend between the first protective element and the second protective element in such a way that the plurality of cavities are defined by the first protective element and the base plate of the support structure. Alternatively or additionally, the cavities may be defined by the first protective element and the second protective element.

A plurality of the cavities can have a width and/or a length in the range from 10 mm to 100 mm, preferably in the range from 30 mm to 60 mm.

The ribs can extend in a regular pattern between the first protective element and the second protective element. The ribs can extend along the longitudinal extension and/or along the width extension of the base plate of the support structure and form a regular pattern. This improves the flexural rigidity of the underbody protection.

The ribs can have a wall thickness in the range of 1.5 mm to 8 mm, preferably in the range of 2 mm to 4 mm.

The first protective element and/or the second protective element can partially cover the ribs of the support structure. This can increase the flexibility of the underbody protection.

Alternatively, the first protective element and/or the second protective element can completely cover the ribs of the support structure. This allows increased flexural rigidity of the underbody protection to be achieved.

The first protective element and/or the second protective element can be connected to the support structure by means of connecting elements. Connecting elements can be designed as screws, rivets or other connecting elements. For example, a cavity with an undercut or a through hole can be formed in the first protective element and/or in the second protective element. The material of the support structure can extend into the cavity so that a rivet is formed in this way. Furthermore, the material of the support structure can extend through a through hole, the wall of which is preferably chamfered, so that a rivet is formed in this way.

The support structure can have connecting receptacles which are designed to connect the first protective element and/or the second protective element to the support structure by means of connecting elements. The connecting receptacles can be arranged on the plurality of ribs.

The underbody protection can have a plurality of first protective elements and second protective elements. This allows increased flexibility of the underbody protection to be achieved.

Preferably, the support structure has a base plate from which the plurality of the ribs extend.

The correspondingly designed underbody protection has further improved stability and is particularly easy to produce.

The plurality of the ribs can extend orthogonally away from the base plate of the support structure. This simplifies the manufacture of the support structure.

The plurality of the ribs can be monolithically connected to the base plate. Monolithically connected are two components that are made from one continuous piece. In particular, monolithically connected components are joined together without joints.

Preferably, the support structure is shell-shaped.

The correspondingly designed underbody protection has further improved stability and is particularly easy to produce.

A shell-shaped component within the meaning of the invention has at least one substantially flat section and at least one edge section which at least partially delimits the flat section and has a component which is orthogonal to the flat section. The edge section can also be referred to as a boundary edge.

The boundary edge can be monolithically connected to the base plate.

The support structure can have a receiving volume that is at least partially limited by the base plate and the boundary edge.

The boundary edge can completely enclose the base plate of the support structure. In other words, the receiving volume can be completely limited by the boundary edge in the direction of the longitudinal extension and the width extension of the base plate by the boundary edge.

The support structure can be designed as a monolithic component.

The first protective element can be arranged in the receiving volume of the support structure. This makes it easier to mount the underbody protection on a motor vehicle.

Preferably, the underbody protection has a connecting flange arranged at an edge.

The connecting flange is preferably designed as part of the support structure. This makes it easier to manufacture the support structure. It also increases the bending stiffness of the support structure.

The connecting flange can extend away from the edge of the support structure, in particular in the direction of the width and/or the longitudinal extension of the base plate of the support structure.

The connecting flange can have an extension in the direction of the width extension and/or the longitudinal extension of the base plate of the support structure in a range from 8 mm to 40 mm, preferably in a range from 10 mm to 18 mm. This allows the underbody protection to be connected to a motor vehicle in an improved manner.

The connecting flange can have a joining surface. The joining surface can be designed to establish a connection with a motor vehicle or a motor vehicle component, such as a traction battery. The connection to the motor vehicle can be a material connection. Alternatively or additionally, a mechanical connection can be established by means of connecting elements. Connecting elements can take the form of screws, rivets or other mechanical connecting elements.

The connecting flange can be designed as part of the boundary edge.

The connecting flange can be designed as a connecting flange running around the support structure.

Preferably, the first protective element is designed as a first organosheet and/or the second protective element is designed as a second organosheet.

Organosheets are semi-finished fiber-matrix products. These con-sist of a fiber fabric or a fiber scrim embedded in a thermoplastic matrix. This can improve hot formability and thus shorten production times. In addition, the bending stiffness of the underbody protection can be improved.

The first protective element and/or the second protective element can have the same plastic as the support structure. This allows the first protective element and/or the second protective element to be connected to the support structure in an improved manner, in particular to be welded in an improved manner.

The first protective element and/or the second protective element can each have a multi-layer structure. Preferably, the multi-layer structure has a first layer. The multilayer structure may comprise a second layer, wherein the second layer is connected to the first layer. The multilayer structure can have a third layer, which is connected to the second layer in such a way that the second layer is sandwiched between the first layer and the third layer. The multilayer structure can have a fourth layer, which is connected to the third layer in such a way that the third layer is sandwiched between the second layer and the fourth layer. The multilayer structure can have a fifth layer, which is connected to the fourth layer in such a way that the fourth layer is sandwiched between the third layer and the fifth layer. The multilayer structure can have a sixth layer, which is connected to the fifth layer in such a way that the fifth layer is sandwiched between the fourth layer and the sixth layer.

The multi-layer structure can have a top layer that is connected to the first layer in such a way that the first layer is sandwiched between the top layer and the second layer.

The first connecting surface of the first protective element can be formed by a first side of the top layer of the multilayer structure. The second connecting surface of the second protective element can be formed by a first side of the top layer of the multilayer structure. Alternatively, the first connecting surface of the first protective element can be formed by a first side of the sixth layer of the multilayer structure. The second connecting surface of the second protective element can be formed by a first side of the sixth layer of the multilayer structure. The layers can be materially bonded together, preferably by welding.

The top layer and/or the sixth layer can comprise a polypropylene and/or a polyethylene terephthalate and/or a mixture of polypropylene and polyethylene terephthalate or be formed from these. Underbody protection formed in this way has the advantage that the top layer and/or the sixth layer do not stick to a welded surface when the first protective element and/or the second protective element are bonded to the support structure. This simplifies the production of the underbody protection.

The first layer and/or the second layer and/or the third layer and/or the fourth layer and/or the fifth layer may comprise or be formed from a fiber-reinforced polypropylene.

The fibers of the fiber-reinforced polypropylene can be in the form of glass fibers and/or aramid fibers and/or carbon fibers.

The first layer and/or the second layer and/or the third layer and/or the fourth layer and/or the fifth layer can have a fiber content of greater than or equal to 50%, preferably greater than or equal to 60% and particularly preferably greater than or equal to 70%. The fiber content corresponds to a volume fraction of the material of the layer.

According to a preferred embodiment, the first layer and/or the third layer and/or the fifth layer may have a fiber content of 72% and the second layer and/or the fourth layer may have a fiber content of 66%.

The first layer and/or the second layer and/or the third layer and/or the fourth layer and/or the fifth layer may have a thickness extension in a range from 0.15 mm to 0.3 mm, preferably in a range from 0.17 mm to 0.25 mm and particularly preferably in a range from 0.19 mm to 0.23 mm.

According to a preferred embodiment, the first layer and/or the third layer and/or the fifth layer can have a thickness extension of 0.195 mm and the second layer and/or the fourth layer can have a thickness extension of 0.23 mm.

The top layer and/or the sixth layer can have a thickness extension in a range from 0.04 mm to 0.13 mm, preferably in a range from 0.05 mm to 0.12 mm and particularly preferably in a range from 0.06 mm to 0.11 mm.

According to a preferred embodiment, the top layer can have a thickness extension of 0.065 mm and the sixth layer a thickness extension of 0.1 mm.

The first layer and the third layer and the fifth layer may have fibers that have a first orientation within the polypropylene material. The second layer and the fourth layer may have fibers that have a second orientation within the polypropylene material. The first orientation may be the same as or different from the second orientation. Preferably, the first orientation is offset from the second orientation by 90°.

The first protective element and/or the second protective element can have a thickness extension in a range from 1 mm to 2 mm, preferably in a range from 1.1 mm to 1.5 mm and particularly preferably in a range from 1.2 mm to 1.3 mm. According to a preferred embodiment, the first protective element and/or the second protective element can have a thickness extension of 1.21 mm.

Preferably, the first protective element is designed as a first metal sheet and/or the second protective element is designed as a second metal sheet.

A protective element designed as a metal sheet has improved isotropic mechanical and thermal properties. In particular, this can improve the isotropic behavior of the underbody protection.

A first metal sheet and/or a second metal sheet can have a steel alloy and/or an aluminum alloy.

The first protective element and/or the second protective element can be partially or completely enclosed by the support structure, in particular by a plastic material of the support structure. As a result, the first protective element and/or the second protective element can be better protected against corrosion.

The first protective element can partially protrude into the connecting flange. In other words, the first protective element can be partially enclosed by a material of the connecting flange. This increases the flexural rigidity of the underbody protection, particularly in the area of the connecting flange.

Preferably, the first protective element and/or the second protective element has/have a wall thickness in a range of 0.1 mm to 6 mm, preferably in a range of 0.5 mm to 4 mm, more preferably in a range of 1 mm to 3 mm.

The inventors have found that even with surprisingly thin protective elements, the protective effect of the underbody protection against mechanical impacts is significantly improved compared to underbody protection devices known from the prior art, while at the same time reducing the weight.

Preferably, the support structure is a plastic component, preferably a fiber-reinforced plastic component.

The correspondingly designed underbody protection has further improved stability and is particularly easy to manufacture. Furthermore, the support structure can be produced in a simplified manner, particularly within one manufacturing step, in particular by injection molding, thermoforming and/or extrusion molding and/or compression molding.

The support structure can be made of thermoplastic material, preferably polypropylene or polyamide.

Alternatively, the support structure can be made of thermosetting plastic.

Preferably, the support structure has a thickness extension in the range from 5 mm to 25 mm, preferably in the range from 8 mm to 20 mm, more preferably in the range from 10 mm to 16 mm.

As a result, the weight of the underbody structure can be further reduced and the efficiency of a vehicle with an appropriately designed underbody protection system can be further increased.

Preferably, a first connecting surface of the first protective element is connected to the support structure by means of a microformed connection and/or a second connecting surface of the second protective element is connected to the support structure by means of a microformed connection.

The correspondingly designed underbody protection is particularly simple, as it can preferably be produced at least partially using tools. Furthermore, the correspondingly designed underbody protection has further improved stability.

A microformed connection in the sense of the invention is understood to be a form fit between two components, whereby one component is at least partially gripped by the other component at a large number of points. As a result, an improved form fit with an increased connection force can be achieved. In addition, two components made of different materials, such as plastic and metal, can be joined together in an improved manner.

Preferably, the first connecting surface and/or the second connecting surface has/have a micro-surface structure.

The micro-surface structure of the first connecting surface and/or the second connecting surface is/are produced, for example, by means of a laser micro-structuring process and/or by means of sandblasting or corundum blasting and/or by means of an etching process.

Preferably, a first connecting surface of the first protective element is connected to the support structure and/or a second connecting surface of the second protective element is connected to the support structure with a material bond.

A material bond can be achieved, for example, by welding and/or gluing the support structure to the first connecting surface and/or the second connecting surface.

Preferably, a first adhesion promoter layer is applied to the first connecting surface and/or a second adhesion promoter layer is applied to the second connecting surface.

The adhesion promoter layer can achieve an improved connection, in particular an improved material bond.

The adhesion promoter layer can be designed as a heat-activated adhesive layer, preferably in the form of a film, a lacquer and/or a powder coating. The powder coating can be thermoplastic or duroplastic based. This can achieve an even better material bond between the support structure and the first protective element and the second protective element.

The adhesion promoter layer can have a layer thickness in the range from 0.02 mm to 3 mm, preferably in the range from 0.03 mm to 1 mm, more preferably in the range from 0.05 mm to 0.3 mm.

Preferably, the underbody protection is designed in such a way that at least some of the cavities are filled with a foam material.

An underbody protection designed in this way has the advantage that the second protective element deforms in the cavities of the support structure, which are at least partially filled with foam material, in the event of a mechanical impact, for example due to an impact caused by the dynamic contact of a motor vehicle with a surface, and can convert the energy generated by the impact into mechanical deformation energy. The first protective element is thereby protected from deformation due to the deformation of the second protective element into the cavities of the underbody protection, which are at least partially filled with foam material, so that components of the motor vehicle located above the first protective element are effectively protected. The foam material in the cavities also absorbs the energy generated by an impact. As a result, the underbody protection has an even better protective effect against mechanical impact.

The foam material can be in the form of polyurethane foam. The foam material can be in the form of expanded polypropylene or EPP foam.

Preferably, the foam material has a density in a range between 60 g/l and 180 g/l, preferably in a range between 100 g/l and 150 g/l.

Furthermore, the underbody protection is preferably designed in such a way that the first protective element is additionally connected to the second protective element by means of the foam material.

The advantage of underbody protection designed in this way is that the flexural rigidity of the underbody protection is further improved.

For example, a part of the first connecting surface of the first protective element can have a polypropylene or be formed from this. A part of the second connecting surface of the second protective element may comprise polypropylene or be formed from polypropylene. The first protective element and the second protective element can each be bonded to the parts of the connecting surfaces comprising polypropylene with the foam material formed as EPP foam, so that the first protective element is connected to the second protective element by means of the foam material.

Alternatively, the first protective element can also be connected to the base plate by means of the foam material. Preferably, the first protective element is bonded to the base plate by means of the foam material.

Alternatively, the first protective element and/or the second protective element can be connected to the foam material by means of a microformed connection.

The problem underlying the present invention is also solved by a motor vehicle, in particular an electric vehicle with an underbody protection as described above, which is attached to an underbody of the motor vehicle, in particular to a traction battery of the motor vehicle.

The problem underlying the present invention is furthermore solved by a method for producing an underbody protection as described above, the method comprising the following method steps:
Manufacture of a support structure;
Inserting a first protective element into a first joining tool;
Inserting the support structure into the first joining tool;
Connecting the first protective element to the support structure;
Inserting a second protective element into the first joining tool or into a second joining tool;
Inserting the support structure into the second joining tool;
Connecting the second protective element to the support structure.

The support structure can be manufactured using an injection molding process, a thermoforming process or an extrusion process. Alternatively, the support structure can be manufactured using a pressing process with thermoset sheet molding compound (SMC).

The first protective element and/or the second protective element can be connected to the support structure using a welding process. Alternatively or additionally, the connection can be made by screwing, riveting or clamping.

The support structure can be manufactured and the first protective element inserted in a single step. In other words, the first protective element can first be inserted into a mold and then the support structure can be produced in the same mold by over-molding and/or overmolding the first protective element. This allows the support structure to be bonded to the first protective element with improved material bonding.

The production of the support structure and the insertion of the second protective element can take place in one step. In other words, the second protective element can first be inserted into a mold and then the support structure can be produced in the same mold by pressing and/or overmolding the second protective element. This allows the support structure to be bonded to the second protective element with improved material bonding.

Further advantages, details and features of the invention are shown in the following embodiments. These show in detail:

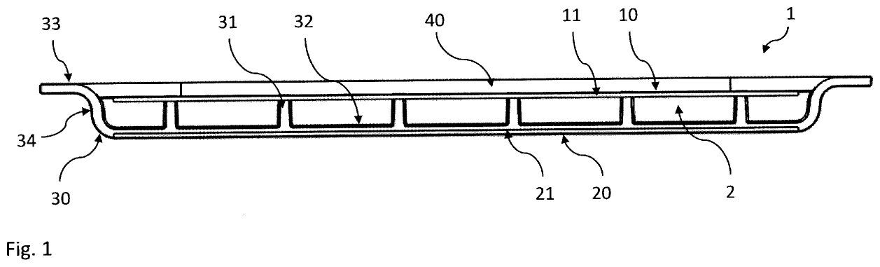

FIG. 1: a schematic sectional view of an underbody protection according to the invention according to a first embodiment;

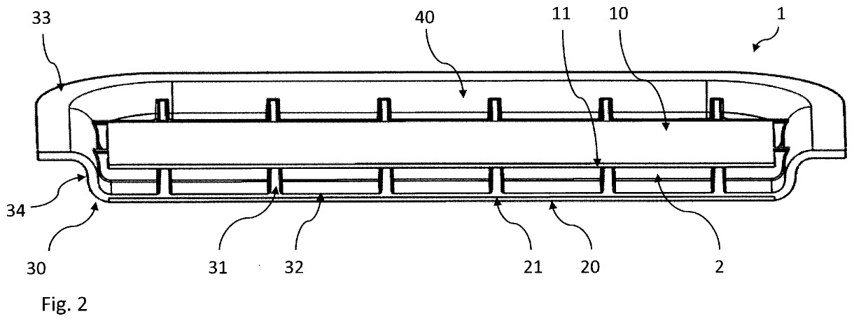

FIG. 2: a schematic, perspective sectional view of an underbody protection according to the invention according to the first embodiment ;

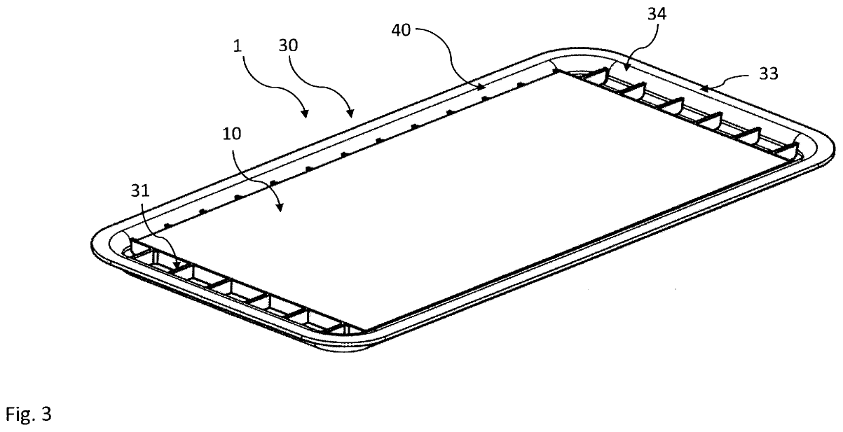

FIG. 3: A perspective view of an underbody protection according to the invention according to the first embodiment;

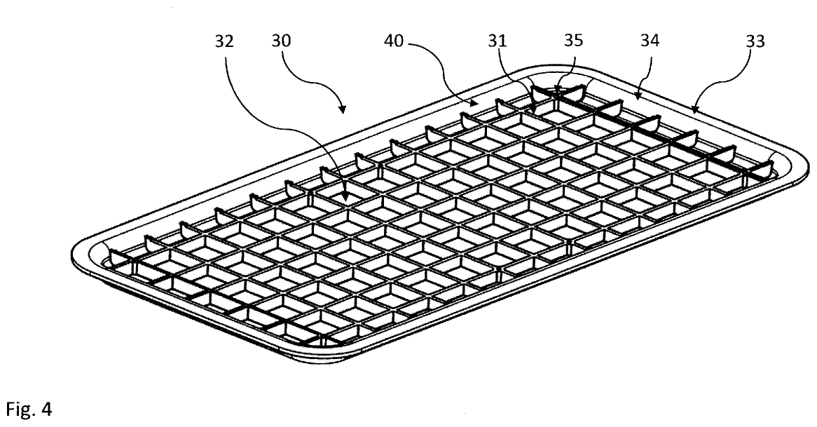

FIG. 4: a perspective view of a support structure of an underbody protection according to the invention according to a second embodiment;

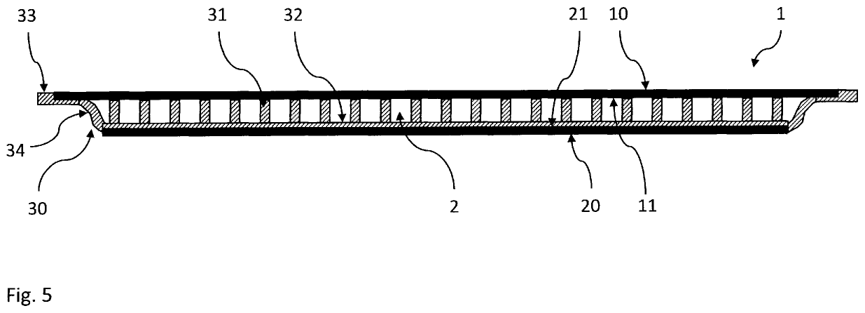

FIG. 5: a schematic sectional view of an underbody protection according to the invention according to a third embodiment; and

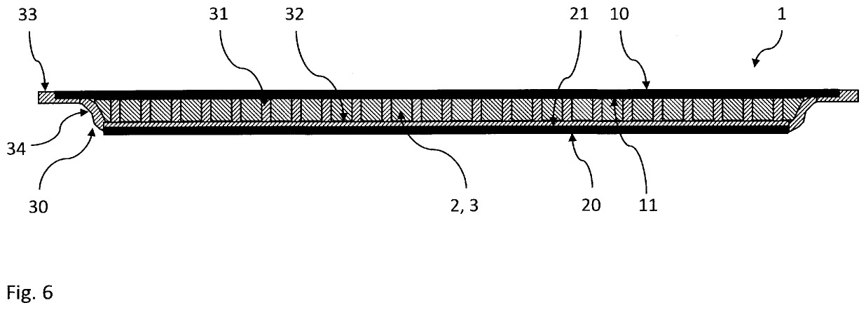

FIG. 6: a schematic sectional view of an underbody protection according to the invention according to a fourth embodiment.

In the following description, the same reference signs denote the same components or the same features, so that a description carried out in relation to one figure with regard to a component also applies to the other figures, so that a repetitive description is avoided. Furthermore, individual features described in connection with one embodiment can also be used separately in other embodiments.

FIG. 1 shows a first embodiment of an underbody protection 1 for a motor vehicle according to the invention in a sectional view. The underbody protection 1 has a first protective element 10 and a second protective element 20 and a support structure 30 sandwiched between the first protective element 10 and the second protective element 20. The first protective element 10 and the second protective element 20 are connected to the support structure 30 on two opposite sides of the latter.

The support structure 30 has a plurality of ribs 31 extending orthogonally away from a base plate 32 of the support structure 30. The plurality of ribs 31 also extend between the first protective element 10 and the second protective element 20, so that a plurality of cavities 2 are formed between the first protective element 10 and the second protective element 20.

The plurality 41 ribs 31 are monolithically connected to the support structure 30. The plurality of ribs 31 extend in the direction of the width extension and the longitudinal extension of the support structure 30 and form a regular pattern.

The first protective element 10 has a first connecting surface 11 and the second protective element 20 has a second connecting surface 21. The first protective element 10 is connected to the ribs 31 of the support structure 30 by means of the first connecting surface 11. The second protective element 20 is connected to the base plate 32 of the support structure 30 by means of the second connecting surface 21.

The underbody protection 1 also has a connecting flange 33 arranged at an edge. The connecting flange 33 is monolithically connected to the support structure 30. The connecting flange 33 extends away from the support structure 30 in the direction of the longitudinal extension and the width extension of the base plate 32. The connecting flange 33 is designed as a connecting flange 33 running around the support structure 30.

The support structure 30 is shell-shaped. The support structure 30 has a boundary edge 34. The boundary edge 34 and the base plate 32 partially delimit a receiving volume 40.

The first protective element 10 is accommodated in the receiving volume 40 of the support structure 30.

In the installation position of the underbody protection 1, the second protective element 20 is arranged starting from a base, followed by the support structure 30 and then the first protective element 10. Thus, in the event of a mechanical impact caused, for example, by a collision with a motor vehicle with an underbody protection 1, the second protective element 20 can deform into the cavities 2 of the support structure 30. This allows energy from the impact to be converted into mechanical deformation energy. As a result, the components of a motor vehicle arranged above the underbody protection 1 are better protected.

FIG. 2 shows a perspective sectional view of the underbody protection 1 according to the first embodiment. The boundary edge 34 has a higher extension in the direction of extension of the ribs 31 than the ribs 31. As a result, the first protective element 10 can additionally deform in the event of an impact without hitting a component of a vehicle. As a result, an increased amount of mechanical deformation energy can be absorbed.

FIG. 3 shows a perspective view of an underbody protection 1 according to the first embodiment. The first protective element 10 partially covers the plurality of ribs 31 of the support structure 30. This increases the flexibility of the underbody protection 1.

FIG. 4 shows a perspective view of a support structure 30 of a second embodiment of an underbody protection 1. The support structure 30 has connecting receptacles 35 for receiving connecting elements. This allows the first protective element 10 and/or the second protective element 20 to be connected to the support structure by means of connecting elements such as screws or rivets, for example.

FIG. 5 shows a third embodiment of an underbody protection 1 for a motor vehicle in a sectional view. The first protective element 10 partially protrudes into the connecting flange 33 of the support structure 30, so that the first connecting surface 11 of the first protective element 10 is connected to both the plurality of ribs 31 and the connecting flange 33. This can further increase the flexural rigidity of the underbody protection 1.

FIG. 6 shows a fourth embodiment of an underbody protection 1 for a motor vehicle in a sectional view. The cavities 2 are filled with a foam material 3. The first protective element 10 is connected to the base plate 32 of the support structure 30 by means of the foam material 3. The first protective element 10 can be connected to the foam material 3 by means of a microformed connection. The base plate 32 can be bonded to the foam material 3.

### LIST OF REFERENCE SYMBOLS

1 Underbody protection
2 Cavity (of the underbody protection)
3 Foam material
10 First protective element/organosheet/metal plate
11 First connecting surface (of the first protective element)
20 Second protective element/organosheet/metal plate
21 Second connecting surface (of the second protective element)
30 Support structure/plastic component
31 Rib (of the support structure)
32 Base plate (of the support structure)
33 Connecting flange
34 Boundary edge
35 Connecting receptacle
40 Receiving volume

1. An underbody protection for a motor vehicle, comprising:
at least one first protective element;
a support structure comprising a plurality of ribs; and
at least one second protective element,
wherein,
the support structure is sandwiched between the first protective element and the second protective element and is connected to each of these, and
wherein the ribs extend between the first protective element and the second protective element, so that a plurality of cavities are formed between the first protective element and the second protective element.

2. The underbody protection according to claim 1, wherein the support structure further comprises a base plate from which the plurality of ribs extend away.

3. The underbody protection according to claim 1, wherein the support structure is shell-shaped.

4. The underbody protection according to claim 1, wherein the underbody protection further comprises a connecting flange arranged at an edge.

5. The underbody protection according to claim 1, wherein the first protective element is designed as a first organosheet and/or the second protective element is designed as a second organosheet.

6. The underbody protection according to claim 1, wherein the first protective element is designed as a first metal sheet and/or the second protective element is designed as a second metal sheet.

7. The underbody protection according to claim 1, wherein the first protective element and/or the second protective element has/have a wall thickness in a range from 0.1 mm to 6 mm.

8. The underbody protection according to claim 1, wherein the support structure is designed as a plastic component.

9. The underbody protection according to claim 1, wherein the support structure has a thickness extension in the range from 5 mm to 25 mm.

10. The underbody protection according to claim 1, wherein a first connecting surface of the first protective element is connected to the support structure by means of a microformed connection and/or a second connecting surface of the second protective element is connected to the support structure by means of a microformed connection.

11. The underbody protection according to claim 10, wherein the first connecting surface and/or the second connecting surface has/have a micro-surface structure.

12. The underbody protection according to claim 1, wherein a first connecting surface of the first protective element is connected to the support structure in a materially bonding manner and/or a second connecting surface of the second protective element is connected to the support structure with a material bond.

13. The underbody protection according to claim 12, wherein a first adhesion promoter layer is applied to the first bonding surface and/or a second adhesion promoter layer is applied to the second bonding surface.

14. The underbody protection according to claim 1, characterized in that at least some of the plurality of cavities are filled with a foam material.

15. A motor vehicle comprising an underbody protection according to claim 1, wherein the underbody protection is attached to an underbody of the motor vehicle.

16. A method of producing an underbody protection, comprising the following steps:
manufacturing a support structure;
inserting a first protective element into a first joining tool;
inserting the support structure into the first joining tool;
connecting the first protective element to the support structure;
inserting a second protective element into the first joining tool or into a second joining tool;
inserting the support structure into the second joining tool; and
connecting the second protective element to the support structure.
